(19) United States
(12) Patent Application Publication
(10) Pub. No.: US 2026/0278643 A1
(43) Pub. Date: Sep. 17, 2026

(54) INFORMATION PROCESSING METHOD AND NON-TRANSITORY COMPUTER READABLE MEDIUM

(71) Applicant: TOYOTA JIDOSHA KABUSHIKI KAISHA, Toyota-shi (JP)

(72) Inventors: Shinji KOJIMA, Niiza-shi (JP); Yuhei MIYAZAWA, Itabashi-ku (JP); Noriyuki FUJIOKA, Nakano-ku (JP)

(73) Assignee: TOYOTA JIDOSHA KABUSHIKI KAISHA, Toyota-shi (JP)

(21) Appl. No.: 19/564,810

(22) Filed: Mar. 12, 2026

(30) Foreign Application Priority Data
Mar. 14, 2025 (JP) 2025-041886

(51) Int. Cl. G06Q 30/0251; G06Q 10/20; H04L 67/55

(52) U.S. Cl. CPC G06Q 30/0265; G06Q 10/20; H04L 67/55

(57) ABSTRACT

An information processing method for an information processing system, including a server apparatus, advertiser terminals, and a user terminal, includes acquiring vehicle information regarding a vehicle for lease including damage information indicating the state of a scratch on the exterior, publishing the vehicle information on a network and receiving, from the advertiser terminals, requests for advertisement placement to affix advertising materials covering the scratch on the exterior of the vehicle, determining an advertiser who places an advertisement based on the requests for advertisement placement received from the advertiser terminals, publishing the determined advertiser's placement condition and vehicle information and receiving, from the user terminal, an application for a lease contract for the vehicle with the determined advertiser's advertisement, and generating contract information to conclude the lease contract for the vehicle with the determined advertiser's advertisement, with the user who operates the user terminal from which the application has been received.

### CROSS-REFERENCE TO RELATED APPLICATION

This application claims priority to Japanese Patent Application No. 2025-041886, filed on Mar. 14, 2025, the entire contents of which are incorporated herein by reference.

### TECHNICAL FIELD

The present disclosure relates to an information processing method and a non-transitory computer readable medium.

### BACKGROUND

Patent Literature (PTL) 1 describes technology related to the evaluation of vehicles returned from lease.

### CITATION LIST

### Patent Literature

PTL 1: JP 2024-030151 A

### SUMMARY

In general, when there is damage requiring repair such as scratches on the exteriors of vehicles returned from lease, it may become difficult to re-lease those vehicles. Conventional lease systems have room for improvement in terms of enabling vehicles with exterior damage to be leased by enhancing asset value without incurring costs.

It would be helpful to enable vehicles with exterior damage to be leased by enhancing asset value without incurring costs.

According to the present disclosure, an information processing method is performed by an information processing system including a server apparatus, one or more advertiser terminals operated by advertisers, and a user terminal operated by a user, which are configured to be communicable with each other via a network, the information processing method including:
acquiring multiple pieces of vehicle information regarding vehicles for lease, the multiple pieces of vehicle information including damage information indicating the states of scratches on the exteriors;
displaying, on each of the one or more advertiser terminals, a first search screen that allows input of a search condition regarding an advertisement placement condition, searching the multiple pieces of vehicle information for a piece of vehicle information that meets the search condition input to the first search screen, and displaying the search result on each of the one or more advertiser terminals;
receiving, from the one or more advertiser terminals, requests for advertisement placement, including advertisement placement conditions, to affix advertising materials covering the scratches on the exteriors of the vehicles;
determining one or more advertisers who place advertisements on the vehicles, based on the requests for advertisement placement received from the one or more advertiser terminals;
displaying, on the user terminal, a second search screen that allows input of a search condition regarding the advertisers' advertisement placement conditions and/or vehicle information, searching the multiple pieces of vehicle information for a piece of vehicle information that meets the search condition input to the second search screen, and displaying the search result on the user terminal;
receiving, from the user terminal, an application for a lease contract for a vehicle on which an advertisement by an advertiser of the determined one or more advertisers is placed; and
generating contract information to conclude the lease contract for the vehicle on which the advertisement by the advertiser of the determined one or more advertisers is placed, with the user who operates the user terminal from which the application has been received.

According to the present disclosure, an information processing method is performed by an information processing system including a server apparatus, one or more advertiser terminals operated by advertisers, and a user terminal operated by a user, which are configured to be communicable with each other via a network, the information processing method including:
acquiring multiple pieces of vehicle information regarding multiple vehicles for lease, the multiple pieces of vehicle information including damage information indicating the states of scratches on the exteriors;
accepting, from the one or more advertiser terminals, registrations of multiple advertisement placement requests, including advertisement placement conditions, to affix advertising materials covering the scratches on the exteriors of the vehicles;
displaying, on the user terminal, a third search screen that allows input of a search condition related to vehicle information, searching the multiple pieces of vehicle information for a piece of vehicle information that meets the search condition input to the third search screen, and displaying the search result on the user terminal;
displaying, on the user terminal, a fourth search screen that allows input of a search condition related to advertisement, searching the multiple advertisement placement requests for an advertisement placement request that meets the search condition input to the fourth search screen, and displaying the search result on the user terminal;
receiving, from the user terminal, an application for a lease contract for a vehicle, the application including a combination of any vehicle of the multiple vehicles and at least one advertisement related to the advertisement placement request; and
generating contract information to conclude the lease contract for the vehicle with the user who operates the user terminal from which the application has been received.

According to the present disclosure, an information processing method is performed by an information processing system including a server apparatus, one or more advertiser terminals operated by advertisers, and a user terminal operated by a user, which are configured to be communicable with each other via a network, the information processing method including:
acquiring vehicle information regarding a vehicle for lease, the vehicle information including damage information indicating the state of a scratch on the exterior;
publishing the vehicle information including the damage information on the network, and receiving, from the one or more advertiser terminals, requests for advertisement placement, including advertisement placement conditions, to affix advertising materials covering the scratch on the exterior of the vehicle;
determining at least one advertiser who places an advertisement on the vehicle, based on the requests for advertisement placement received from the one or more advertiser terminals;
publishing an advertisement placement condition of the determined at least one advertiser and the vehicle information on the network, and receiving, from the user terminal, an application for a lease contract for the vehicle on which the advertisement by the determined at least one advertiser is placed; and
generating contract information to conclude the lease contract for the vehicle on which the advertisement by the determined at least one advertiser is placed, with the user who operates the user terminal from which the application has been received.

According to the present disclosure, an information processing method is performed by an information processing system including a server apparatus, one or more advertiser terminals operated by advertisers, and a user terminal operated by a user, which are configured to be communicable with each other via a network, the information processing method including:
acquiring vehicle information regarding a vehicle for lease, the vehicle information including damage information indicating the state of a scratch on the exterior;
publishing the vehicle information including the damage information on the network, and receiving, from the user terminal, an application for a lease contract for the vehicle;
generating contract information to conclude the lease contract for the vehicle with the user who operates the user terminal from which the application has been received;
receiving, from the user, a desired condition related to advertisement placement to affix an advertising material covering the scratch on the exterior of the vehicle;
publishing the vehicle information including the damage information and the desired condition on the network, and receiving, from the one or more advertiser terminals, requests for advertisement placement, including advertisement placement conditions, for the vehicle; and
determining an advertiser who places an advertisement on the vehicle, based on the requests for advertisement placement received from the one or more advertiser terminals.

According to the present disclosure, an information processing method is performed by an information processing system including a server apparatus, one or more advertiser terminals operated by advertisers, and a user terminal operated by a user, which are configured to be communicable with each other via a network, the information processing method including:
acquiring multiple pieces of vehicle information regarding multiple vehicles for lease, the multiple pieces of vehicle information including damage information indicating the states of scratches on the exteriors;
accepting, from the one or more advertiser terminals, registrations of advertisement placement requests, including advertisement placement conditions, to affix advertising materials covering the scratches on the exteriors of the vehicles;
publishing the multiple pieces of vehicle information and the advertisement placement requests on the network, and receiving, from the user terminal, an application for a lease contract for a vehicle, the application including a combination of any vehicle of the multiple vehicles and at least one advertisement related to an advertisement placement request; and
generating contract information to conclude the lease contract for the vehicle with the user who operates the user terminal from which the application has been received.

According to the present disclosure, a program is configured to control a computer configured to be communicable with one or more advertiser terminals operated by advertisers and a user terminal operated by a user via a network, the program configured to cause a processor to execute operations, the operations including:
acquiring vehicle information regarding a vehicle for lease, the vehicle information including damage information indicating the state of a scratch on the exterior;
publishing the vehicle information including the damage information on the network, and receiving, from the one or more advertiser terminals, requests for advertisement placement, including advertisement placement conditions, to affix advertising materials covering the scratch on the exterior of the vehicle;
determining at least one advertiser who places an advertisement on the vehicle, based on the requests for advertisement placement received from the one or more advertiser terminals;
publishing an advertisement placement condition of the determined at least one advertiser and the vehicle information on the network, and receiving, from the user terminal, an application for a lease contract for the vehicle on which the advertisement by the determined at least one advertiser is placed; and
generating contract information to conclude the lease contract for the vehicle on which the advertisement by the determined at least one advertiser is placed, with the user who operates the user terminal from which the application has been received.

According to the present disclosure, a program is configured to control a computer configured to be communicable with one or more advertiser terminals operated by advertisers and a user terminal operated by a user via a network, the program configured to cause a processor to execute operations, the operations including:
acquiring vehicle information regarding a vehicle for lease, the vehicle information including damage information indicating the state of a scratch on the exterior;
publishing the vehicle information including the damage information on the network, and receiving, from the user terminal, an application for a lease contract for the vehicle;
generating contract information to conclude the lease contract for the vehicle with the user who operates the user terminal from which the application has been received;
receiving, from the user, a desired condition related to advertisement placement to affix an advertising material covering the scratch on the exterior of the vehicle;
publishing the vehicle information including the damage information and the desired condition on the network, and receiving, from the one or more advertiser terminals, requests for advertisement placement, including advertisement placement conditions, for the vehicle; and
determining an advertiser who places an advertisement on the vehicle, based on the requests for advertisement placement received from the one or more advertiser terminals.

According to the present disclosure, a program is configured to control a computer configured to be communicable with one or more advertiser terminals operated by advertisers and a user terminal operated by a user via a network, the program configured to cause a processor to execute operations, the operations including:
acquiring multiple pieces of vehicle information regarding multiple vehicles for lease, the multiple pieces of vehicle information including damage information indicating the states of scratches on the exteriors;
accepting, from the one or more advertiser terminals, registrations of advertisement placement requests, including advertisement placement conditions, to affix advertising materials covering the scratches on the exteriors of the vehicles;
publishing the multiple pieces of vehicle information and the advertisement placement requests on the network, and receiving, from the user terminal, an application for a lease contract for a vehicle, the application including a combination of any vehicle of the multiple vehicles and at least one advertisement related to an advertisement placement request; and
generating contract information to conclude the lease contract for the vehicle with the user who operates the user terminal from which the application has been received.

According to an embodiment of the present disclosure, it is possible to enable vehicles with exterior damage to be leased by enhancing asset value without incurring costs.

### BRIEF DESCRIPTION OF THE DRAWINGS

In the accompanying drawings:

FIG. 1 is a diagram illustrating an example configuration of an information processing system according to an embodiment;

FIG. 2 is a diagram illustrating an example of covering damage on a vehicle with a sticker;

FIG. 3 is a block diagram illustrating an example configuration of a server apparatus;

FIG. 4 is a block diagram illustrating an example configuration of an operator terminal;

FIG. 5 is a block diagram illustrating an example configuration of an advertiser terminal;

FIG. 6 is a block diagram illustrating an example configuration of a user terminal;

FIG. 7 is a sequence chart illustrating operation example 1 of the information processing system;

FIG. 8 is a sequence chart illustrating operation example 2 of the information processing system; and

FIG. 9 is a sequence chart illustrating operation example 3 of the information processing system.

### DETAILED DESCRIPTION

An embodiment of the present disclosure will be described below, with reference to the drawings. In the drawings, portions having the same configuration or function are denoted by the same reference numeral. In the description of the present embodiment, duplicate descriptions of the same portions are in some cases omitted or simplified, as appropriate.

### Information Processing System 1

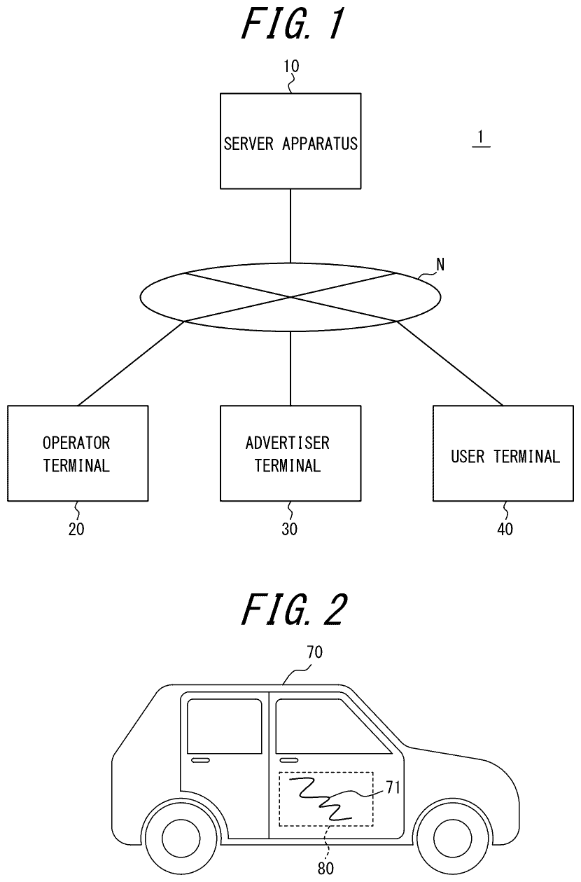

FIG. 1 is a diagram illustrating an example configuration of an information processing system 1 according to the embodiment. FIG. 2 is a diagram illustrating an example of covering damage 71 on a vehicle 70 with a sticker 80 such as an advertisement sticker.

When vehicles 70 leased by a leasing operator to users are returned, there may be significant damage 71 on the exteriors of the vehicles 70. In such cases, when there are no issues with the interiors and internal devices of the vehicles 70, the vehicles 70 still have utility value. However, the damage 71 significantly decreases the value of the vehicles 70, which may make it difficult to lease those vehicles 70 again as is. In the present embodiment, when there is damage 71 that poses no safety issues on the vehicles 70, the leasing operator covers those parts with stickers 80 (advertising materials) such as advertisement stickers provided by advertisers, thereby creating new asset value and releasing the vehicles 70. According to such a scheme, not only can the vehicles 70 be re-leased, but covering the damage 71 with the advertisement stickers allows advertising fees to be collected from the advertisers and to be returned to the leasing operator and users. In such a scheme in which the vehicles 70 with the damage 71 are re-leased by covering the damage 71 with the advertisers' stickers 80, the information processing system 1 achieves matching between a vehicle, an advertiser, and a user.

As illustrated in FIG. 1, the information processing system 1 includes a server apparatus 10, an operator terminal 20, an advertiser terminal 30, and a user terminal 40. The server apparatus 10, the operator terminal 20, the advertiser terminal 30, and the user terminal 40 can communicate with each other via a network N.

The server apparatus 10 is a computer that performs processing to achieve matching between a vehicle, an advertiser, and a user. The server apparatus 10 manages, for each vehicle 70 for lease, vehicle information including damage information indicating the state of a scratch on the exterior, in a database. The vehicle information may include, for example, a vehicle type, interior information, internal device information, the damage information indicating the state of a scratch on the exterior (such as the position of the scratch and the area of the scratch), and the like. The server apparatus 10 provides a website or the like that allows the advertisers and the users to search for and select desired vehicle information. The server apparatus 10 may be, for example, a server apparatus installed in a data center or the like, or a server apparatus belong to a cloud computing system or other computing systems.

The operator terminal 20 is a computer operated by the leasing operator of the vehicles 70. The advertiser terminal 30 is a computer operated by an advertiser. The user terminal 40 is a computer operated by a user who leases a vehicle 70. The operator terminal 20, the advertiser terminal 30, and the user terminal 40 may access the server apparatus 10 via, for example, a web browser or dedicated application software. The operator terminal 20, the advertiser terminal 30, and the user terminal 40 may be general purpose electronic devices such as personal computers (PCs), smartphones, tablet terminals, or wearable terminals, or dedicated electronic devices.

The network N is any communication medium such as the Internet, intranet, and mobile communication networks. The server apparatus 10, the operator terminal 20, the advertiser terminal 30, and the user terminal 40 are communicably connected via the network N.

In FIG. 1, one server apparatus 10, one operator terminal 20, one advertiser terminal 30, and one user terminal 40 are illustrated, but the information processing system 1 may include multiple units of these apparatuses. In the present embodiment, the leasing operator accesses the server apparatus 10 via the operator terminal 20, but the present embodiment is not limited to this configuration. For example, the server apparatus 10 and the operator terminal 20 may be realized by the same computer.

In such a configuration, when there is damage 71 on the exteriors of the vehicles 70, the information processing system 1 achieves matching between a vehicle 70, an advertiser, and a user in the scheme that assumes re-leasing of the vehicles 70 with the damage 71 by covering the damage 71 with the stickers 80 such as advertisement stickers. Specifically, in operation example 1, the information processing system 1 publishes the vehicle information on each vehicle 70 to the advertisers and determines an advertiser, and then publishes the various conditions of the vehicle 70 with an advertisement to the users and concludes a lease contract in response to an lease application from a user. In operation example 2, the information processing system 1 publishes the vehicle information on each vehicle 70 to the users and concludes a lease contract with a user, and then publishes the various conditions of the vehicle 70 to the advertisers and determines an advertiser through an auction or the like. In operation example 3, the information processing system 1 publishes the vehicle information on the vehicles 70 and the advertisers' desired conditions to the users, and accepts, from a user, a selection of a combination of a vehicle 70 and an advertisement to conclude a lease contract.

Therefore, according to the information processing system 1, even for the vehicles 70 with the scratches on the exteriors, it is possible to enhance the asset value by placing the advertisements covering the scratches, allowing for appropriate profit distribution among the advertisers, the users, and the leasing operator when re-leasing the vehicles 70.

### Server Apparatus 10

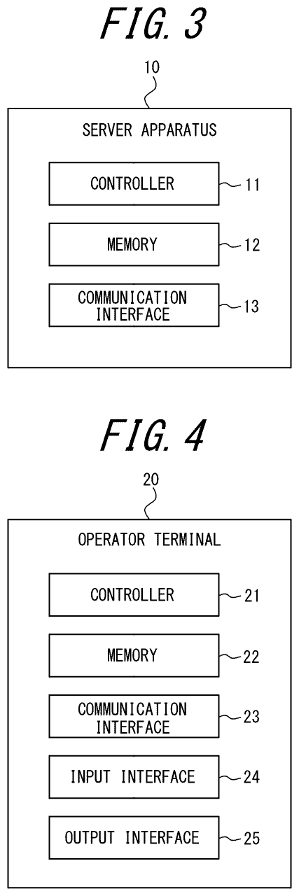

FIG. 3 is a block diagram illustrating an example configuration of the server apparatus 10. The server apparatus 10 includes a controller 11, a memory 12, and a communication interface 13.

The controller 11 includes at least one processor. In one embodiment, the “processor” is a general purpose processor or a dedicated processor specialized for specific processing, but is not limited to these. The controller 11 is communicably connected to the components that constitute the server apparatus 10 and controls operations of the entire server apparatus 10.

The memory 12 includes any memory module such as a hard disk drive (HDD), a solid state drive (SSD), read-only memory (ROM), and random access memory (RAM). The memory 12 may function as, for example, a main memory, an auxiliary memory, or a cache memory. The memory 12 stores any information to be used for operations of the server apparatus 10. For example, the memory 12 may store a system program, an application program, various types of information received by the communication interface 13, and the like. The memory 12 is not limited to being built into the server apparatus 10, and may also be an external database or an external memory module. The memory 12 may be provided as network storage connected to the network N.

The memory 12 may hold a database that manages, for each vehicle 70 for lease, vehicle information including damage information indicating the state of a scratch on the exterior. The vehicle information may include, for example, a vehicle type, color, model year, interior information, internal device information, the damage information indicating the state of a scratch on the exterior (such as the position of the scratch and the area of the scratch), and the like. The vehicle information may include captured images acquired by imaging an area around the scratch with a camera. The vehicle information may include the conditions of the size and shape of a sticker 80 necessary to cover the scratch on the exterior of the vehicle 70.

The communication interface 13 includes any communication module capable of communicating with other apparatuses using any communication technology. The communication interface 13 may further include a communication control module for controlling communication with other apparatuses, and a memory module for storing communication data such as identification information necessary for communication with other apparatuses.

The functions of the server apparatus 10 may be realized by executing a computer program (program) according to the present embodiment on a processor included in the controller 11. That is, the functions of the server apparatus 10 may be realized by software. The computer program causes a computer to execute the processes of steps included in operations of the server apparatus 10, thereby enabling the computer to realize functions corresponding to the processes of the steps. That is, the computer program is a program for causing the computer to function as the server apparatus 10 according to the present embodiment.

The computer program can be recorded on a computer readable recording medium. The computer readable recording medium is, for example, a magnetic recording device, an optical disc, a magneto-optical recording medium, or a semiconductor memory. The program is distributed, for example, by selling, transferring, or lending a portable recording medium such as a digital versatile disc (DVD) or a universal serial bus (USB) memory on which the program is recorded. The program may be distributed by storing the program in the storage of a server and transferring the program from the server to another computer via a network. The program may also be provided as a program product.

For example, the computer may temporarily store, in the main memory, the program recorded on the portable recording medium or the program transferred from the server. Then, the computer may read the program stored in the main memory using the processor, and execute processes in accordance with the read program using the processor. The computer may read the program directly from the portable recording medium, and execute processes in accordance with the program. The computer may, each time a program is transferred from the server to the computer, sequentially execute processes in accordance with the received program. Such processing may be executed by a so-called ASP type service that realizes functions merely by execution instructions and result acquisitions, without transferring the program from the server to the computer. The term “ASP” is an abbreviation of application service provider. The program encompasses information that is to be used for processing by an electronic computer and is thus equivalent to a program. For example, data that is not a direct command to a computer but has a property that regulates processing of the computer is “equivalent to a program” in this context.

Some or all of the functions of the server apparatus 10 may be realized by a dedicated circuit included in the controller 11. That is, some or all of the functions of the server apparatus 10 may be realized by hardware. The server apparatus 10 may be realized by a single computer or by the collaboration of multiple computers.

### Operator Terminal 20

FIG. 4 is a block diagram illustrating an example configuration of the operator terminal 20. The operator terminal 20 includes a controller 21, a memory 22, a communication interface 23, an input interface 24, and an output interface 25. The controller 21, memory 22, and communication interface 23 of the operator terminal 20 are similar to the controller 11, memory 12, and communication interface 13 of the server apparatus 10, so detailed explanations are omitted.

The input interface 24 includes at least one input interface for accepting a user's input operations and acquiring input information based on the user's operations. For example, the input interface 24 includes a physical key, a capacitive key, a pointing device, a touch screen integrally provided with a display of the output interface 25, a microphone that accepts audio input, or the like, but is not limited to these.

The output interface 25 includes at least one output interface for outputting information to the user and notifying the user. For example, the output interface 25 includes a display for outputting information as images, a speaker for outputting information as audio, or the like, but is not limited to these. Such a display may be, for example, a liquid crystal panel display or an organic electro luminescent (EL) display. The above-described input interface 24 and/or output interface 25 may be configured integrally with the operator terminal 20 or may be provided separately.

As with the server apparatus 10, the functions of the operator terminal 20 may be realized by software or by hardware. The operator terminal 20 may be realized by a single computer or by the collaboration of multiple computers that can communicate with each other.

### Advertiser Terminal 30

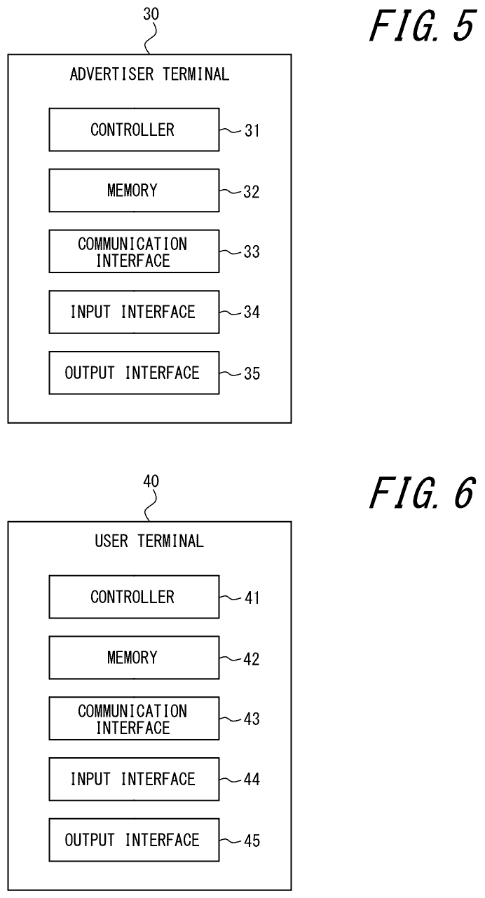

FIG. 5 is a block diagram illustrating an example configuration of the advertiser terminal 30. The advertiser terminal 30 includes a controller 31, a memory 32, a communication interface 33, an input interface 34, and an output interface 35. The controller 31, memory 32, communication interface 33, input interface 34, and output interface 35 of the advertiser terminal 30 are similar to the controller 11, memory 12, and communication interface 13 of the server apparatus 10, and the input interface 24 and output interface 25 of the operator terminal 20, so detailed explanations are omitted.

As with the server apparatus 10, the functions of the advertiser terminal 30 may be realized by software or by hardware. The advertiser terminal 30 may be realized by a single computer or by the collaboration of multiple computers that can communicate with each other.

### User Terminal 40

FIG. 6 is a block diagram illustrating an example configuration of the user terminal 40. The user terminal 40 includes a controller 41, a memory 42, a communication interface 43, an input interface 44, and an output interface 45. The controller 41, memory 42, communication interface 43, input interface 44, and output interface 45 of the user terminal 40 are similar to the controller 11, memory 12, and communication interface 13 of the server apparatus 10, and the input interface 24 and output interface 25 of the operator terminal 20, so detailed explanations are omitted.

As with the server apparatus 10, the functions of the user terminal 40 may be realized by software or by hardware. The user terminal 40 may be realized by a single computer or by the collaboration of multiple computers that can communicate with each other.

### Operation Example 1

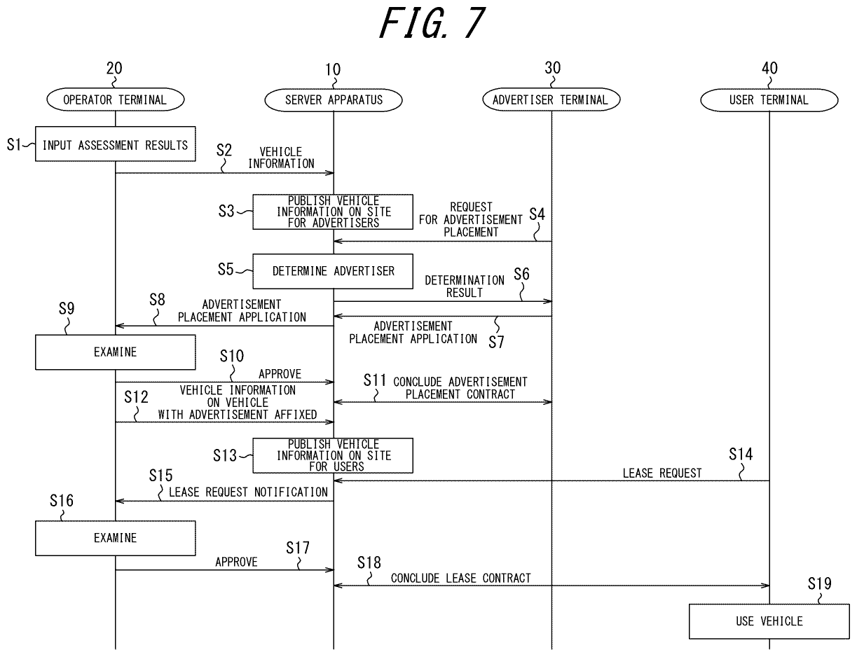

FIG. 7 is a sequence chart illustrating operation example 1 of the information processing system 1. In operation example 1, after determining an advertiser, the information processing system 1 publishes the various conditions of a vehicle 70 with an advertisement to users, and concludes a lease contract in response to an lease application from a user. The operations of the information processing system 1 described with reference to FIG. 7 can correspond to one of information processing methods according to the present embodiment. The operation of each step in FIG. 7 may be executed based on control by the controller 11 of the server apparatus 10, the controller 21 of the operator terminal 20, the controller 31 of the advertiser terminal 30, and/or the controller 41 of the user terminal 40. The following processing is executed in a situation in which vehicles 70 including damage 71 have been returned to a leasing operator, and the leasing operator has conducted an assessment of each vehicle 70.

In S1, the controller 21 of the operator terminal 20 accepts input of the assessment results by the leasing operator. Specifically, the controller 21 accepts input, by the leasing operator, of vehicle information including color, model year, vehicle type, interior information, internal device information, damage information indicating the state of a scratch on the exterior (such as the position of the scratch and the area of the scratch), and the like. The controller 21 may acquire, as the vehicle information, a captured image acquired by imaging an area around the scratch. The controller 21 may also acquire, as the vehicle information, the conditions of the size and shape of a sticker 80 necessary to cover the scratch, according to the position and size of the scratch.

In S2, the controller 21 of the operator terminal 20 transmits the vehicle information acquired in S1 to the server apparatus 10 via the communication interface 23. Upon receiving the vehicle information from the operator terminal 20, the controller 11 of the server apparatus 10 registers the vehicle information in a database of the memory 12.

In S3, the controller 11 of the server apparatus 10 publishes the vehicle information on a website for advertisers. The website for advertisers may include a search screen, and have the function of searching numerous pieces of vehicle information for those that meet search conditions input to the search screen and providing the search results. The website for advertisers may provide detailed vehicle information on a vehicle 70 selected on the advertiser terminal 30, from among the multiple vehicles 70 listed as the search results. The provided vehicle information may include information such as a minimum fee and a duration for advertisement placement. The controller 11 publishes such vehicle information during a predetermined recruitment period to solicit an advertiser for each vehicle 70. Each advertiser accesses such a website using the advertiser terminal 30, and searches for and selects a vehicle 70 that meets desired advertisement placement conditions.

In S4, the controller 31 of each advertiser terminal 30 transmits a request for advertisement placement for the vehicle 70 selected by the advertiser to the server apparatus 10 via the communication interface 33. Specifically, the controller 31 may transmit information such as the image and size of an advertisement sticker desired to be placed, conditions for a desired advertising fee, and a placement duration to the server apparatus 10 as the request for advertisement placement.

In S5, the controller 11 of the server apparatus 10 determines an advertiser for each vehicle 70. Specifically, when there is only one application from an advertiser for the vehicle 70 during the recruitment period, the controller 11 may grant an advertising placement right to that advertiser. When there are multiple applications from advertisers for the vehicle 70, the controller 11 may grant an advertising placement right to an advertiser who has offered the highest advertising fee through a bidding method (auction method).

In S6, the controller 11 of the server apparatus 10 transmits the determination result, including the approval or disapproval of the application to each advertiser terminal 30 that has applied for advertise placement, based on the determination result of S5.

In S7, the controller 31 of the advertiser terminal 30 that has been granted the advertising placement right transmits an advertisement placement application to the server apparatus 10.

In S8, the controller 11 of the server apparatus 10 notifies the operator terminal 20 that there has been an advertisement placement application from the advertiser terminal 30 that has been granted the advertising placement right.

In S9, the controller 21 of the operator terminal 20 examines whether to approve the advertisement placement of the advertiser to whom the advertising placement right has been granted, based on the determination of the leasing operator. For example, the leasing operator may determine whether to allow the advertisement placement based on the information such as the image and size of the advertisement sticker desired to be placed, the conditions for the desired advertising fee, and the placement duration. For example, when the advertisement sticker to be affixed as a sticker 80 is deemed inappropriate for affixing in light of public order and morals, the advertisement placement may be disallowed.

In S10, when approving the advertisement placement based on the results of the examination in S9, the controller 21 of the operator terminal 20 notifies the server apparatus 10 of the approval.

In S11, the controller 11 of the server apparatus 10 generates contract information for the leasing operator and the advertiser to conclude an advertisement placement contract. For example, the controller 11 may generate information on a contract document that specifies contract conditions, and accept the advertiser's approval via the advertiser terminal 30. The contract conditions may include information identifying the vehicle 70 on which the advertisement is placed.

In S12, the controller 21 of the operator terminal 20 transmits, to the server apparatus 10, vehicle information on the vehicle 70 with the advertisement affixed. The vehicle information may include, for example, an image of the vehicle 70 with the sticker 80 affixed to the damage 71, the position and size of the sticker 80, leasing conditions, and the like.

In S13, the controller 11 of the server apparatus 10 publishes the vehicle information on a website for users. The website for users may include a search screen, and have the function of searching numerous pieces of vehicle information for those that meet search conditions input to the search screen and providing the search results. The website for users may provide detailed vehicle information on a vehicle 70 selected on the user terminal 40, from among the multiple vehicles 70 listed as the search results. The provided vehicle information may include information such as a lease fee and a duration. The controller 11 publishes such vehicle information to solicit a user for each vehicle 70. Each user accesses such a website using the user terminal 40, and searches for and selects a vehicle 70 that meets desired advertisement placement conditions.

In S14, the controller 41 of the user terminal 40 transmits a lease request for the vehicle 70 selected by the user to the server apparatus 10 via the communication interface 43.

In S15, the controller 11 of the server apparatus 10 notifies the operator terminal 20 that there has been a lease request from the user terminal 40 for the vehicle 70.

In S16, the controller 21 of the operator terminal 20 examines whether to approve the lease to the user, based on the determination of the leasing operator. For example, the leasing operator may determine whether to approve the lease based on the presence or absence of the user's driver's license, the availability and size of parking space for the vehicle 70, the user's credit information regarding payment ability (e.g., annual income, occupation, and loan balance), and the like.

In S17, when approving the lease based on the results of the examination in S16, the controller 21 of the operator terminal 20 notifies the server apparatus 10 of the approval.

In S18, the controller 11 of the server apparatus 10 generates contract information for the leasing operator and the user to conclude a lease contract. For example, the controller 11 may generate information on a contract document that specifies contract conditions, and accept the user's approval via the user terminal 40.

In S19, the controller 41 of the user terminal 40 starts the use of the vehicle by the user. Specifically, the user leases the vehicle 70 from the leasing operator.

The user may receive the advertising fee directly from the advertiser while paying the lease fee to the leasing operator. In this case, the contract information generated in S18 may include information that the advertiser pays the advertising fee to the user. Thus, generating the contract information that includes the information that the advertiser pays the advertising fee to the user can achieve a scheme in which the advertising fee is directly received from the advertiser. The leasing operator may receive the advertising fee from the advertiser, and the user may pay the lease fee to the leasing operator after deducting an amount equivalent to the advertising fee. In this case, the contract information generated in S18 may include information that the lease fee for the vehicle is discounted by an amount equivalent to the advertising fee related to the advertisement placed on that vehicle. In this case, generating the contract information that includes the information that the lease fee for the vehicle is discounted by an amount equivalent to the advertising fee related to the advertisement placed on that vehicle can achieve a scheme in which the advertising fee is deducted from the lease fee.

As described above, in operation example 1, after determining an advertiser, the information processing system 1 publishes the various conditions of a vehicle 70 with an advertisement to users, and concludes a lease contract in response to a lease application from a user. Therefore, each user can select a desired vehicle from among vehicles combined with advertisements, and apply for a lease contract. Each advertiser can place an advertisement on a vehicle that meets advertisement placement conditions.

The information processing system 1 determines an advertiser who places an advertisement on a vehicle using a bidding (auction) method, based on requests for advertisement placement received from one or more advertiser terminals 30. Therefore, the information processing system 1 can determine an optimal advertiser for the leasing operator and user by determining the advertiser from among multiple advertisers through a bidding method.

The information processing system 1 may accept an examination, by the leasing operator, of advertisement placement conditions included in each of requests for advertisement placement received from one or more advertiser terminals 30. The information processing system 1 may subject a request for advertisement placement related to advertisement placement conditions that have passed the examination to bidding. Therefore, the information processing system 1 can prevent advertisements that violate public order by accepting examinations for advertisement placement.

### Operation Example 2

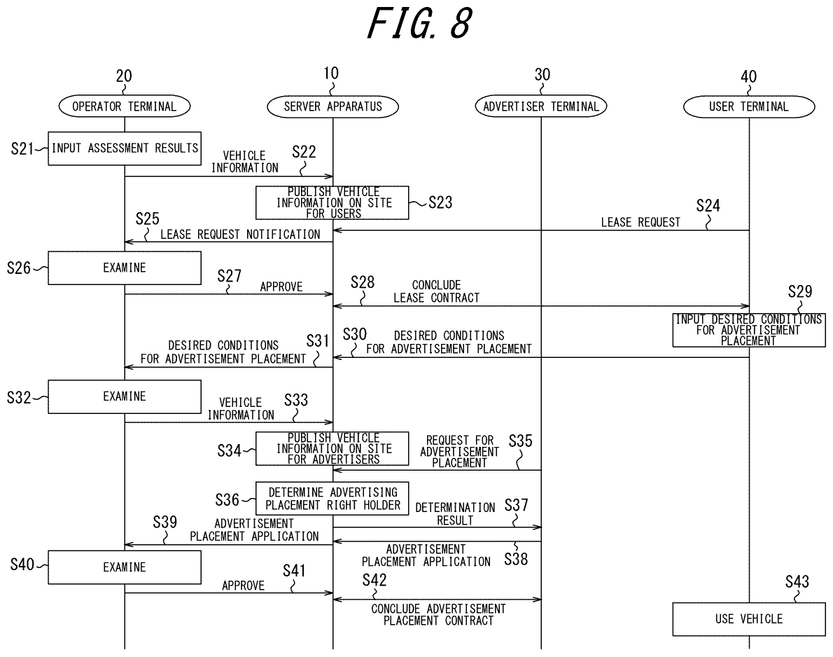

FIG. 8 is a sequence chart illustrating operation example 2 of the information processing system 1. In operation example 2, the information processing system 1 publishes vehicle information on a vehicle 70 to users and concludes a lease contract with a user, and then publishes the various conditions of the vehicle 70 to advertisers to determine an advertiser. The operations of the information processing system 1 described with reference to FIG. 8 can correspond to one of information processing methods according to the present embodiment. The operation of each step in FIG. 8 may be executed based on control by the controller 11 of the server apparatus 10, the controller 21 of the operator terminal 20, the controller 31 of the advertiser terminal 30, and/or the controller 41 of the user terminal 40. The following processing is executed in a situation in which vehicles 70 including damage 71 have been returned to a leasing operator, and the leasing operator has conducted an assessment of each vehicle 70.

In S21, the controller 21 of the operator terminal 20 accepts input of the assessment results from the leasing operator. The processing in S21 may be performed in a similar manner to that in S1 of FIG. 7.

In S22, the controller 21 of the operator terminal 20 transmits vehicle information acquired in S21 to the server apparatus 10 via the communication interface 23. Upon receiving the vehicle information from the operator terminal 20, the controller 11 of the server apparatus 10 registers the vehicle information in a database of the memory 12.

In S23, the controller 11 of the server apparatus 10 publishes the vehicle information on a website for users. The processing in S23 may be performed in a similar manner to that in S13 of FIG. 7.

In S24, the controller 41 of the user terminal 40 transmits a lease request for a vehicle 70 selected by a user to the server apparatus 10 via the communication interface 43.

In S25, the controller 11 of the server apparatus 10 notifies the operator terminal 20 that there has been a lease request for the vehicle 70 from the user terminal 40.

In S26, the controller 21 of the operator terminal 20 examines whether to approve the lease to the user, based on the determination of the leasing operator. The processing in S26 may be performed in a similar manner to that in S16 of FIG. 7.

In S27, when approving the lease based on the results of the examination in S26, the controller 21 of the operator terminal 20 notifies the server apparatus 10 of the approval.

In S28, the controller 11 of the server apparatus 10 generates contract information for the leasing operator and the user to conclude a lease contract. The processing in S28 may be performed in a similar manner to that in S18 of FIG. 7.

In S29, the controller 41 of the user terminal 40 accepts input of desired conditions for advertisement placement for an advertisement to be placed on the vehicle 70 for lease. For example, the desired conditions for advertisement placement may include an advertising fee, an advertisement placement period, the color and size of stickers 80, the industry of advertisers, company names, brands, and the like.

In S30, the controller 41 of the user terminal 40 transmits the desired conditions for advertisement placement input in S29 to the server apparatus 10.

In S31, the controller 11 of the server apparatus 10 notifies the operator terminal 20 of reception of the desired conditions for advertisement placement from the user terminal 40 that has concluded the lease contract.

In S32, the controller 21 of the operator terminal 20 examines whether to approve the desired conditions for advertisement placement input by the user, based on the determination of the leasing operator. For example, when the industry of the advertisers is deemed inappropriate for advertisement placement in light of public order and morals, the leasing operator may not approve the desired conditions for advertisement placement. When approving the desired conditions for advertisement placement, the controller 21 adds the approved desired conditions for advertisement placement to the vehicle information on the vehicle 70 for which the lease contract has been concluded with the user.

In S33, the controller 21 of the operator terminal 20 transmits the vehicle information including the approved desired conditions for advertisement placement to the server apparatus 10.

In S34, the controller 11 of the server apparatus 10 publishes the vehicle information including the desired conditions for advertisement placement on a website for advertisers. The processing in S34 may be performed in a similar manner to that in S3 of FIG. 7. The vehicle information may include information such as a main area, time zone, and day of the week in which the user uses the vehicle 70, and the purpose of use of the vehicle 70 (for example, commuting, leisure, or the like). Each advertiser accesses such a website using the advertiser terminal 30, and searches for and selects a vehicle 70 that meets desired advertisement placement conditions.

In S35, the controller 31 of each advertiser terminal 30 transmits a request for advertisement placement on the vehicle 70 selected by the advertiser to the server apparatus 10 via the communication interface 33. The processing in S35 may be performed in a similar manner to that in S4 of FIG. 7.

In S36, the controller 11 of the server apparatus 10 determines an advertiser. The processing in S36 may be performed in a similar manner to that in S5 of FIG. 7. The controller 11 may disallow a request for advertisement placement that does not meet the desired conditions for advertisement placement specified by the user.

In S37, the controller 11 of the server apparatus 10 transmits the determination result, including the approval or disapproval of the application to each advertiser terminal 30 that has applied for advertise placement, based on the determination result of S36.

In S38, the controller 31 of the advertiser terminal 30 that has been granted an advertising placement right transmits an advertisement placement application to the server apparatus 10.

In S39, the controller 11 of the server apparatus 10 notifies the operator terminal 20 that there has been an advertisement placement application from the advertiser terminal 30 that has been granted the advertising placement right.

In S40, the controller 21 of the operator terminal 20 examines whether to approve the advertisement placement by the advertiser to whom the advertising placement right has been granted, based on the determination of the leasing operator. The processing in S40 may be performed in a similar manner to that in S9 of FIG. 7. The controller 21 may disallow a request for advertisement placement that does not meet the desired conditions for advertisement placement specified by the user.

In S41, when approving the advertisement placement based on the results of the examination in S40, the controller 21 of the operator terminal 20 notifies the server apparatus 10 of the approval.

In S42, the controller 11 of the server apparatus 10 generates contract information for the leasing operator and the advertiser to conclude an advertisement placement contract. The processing in S42 may be performed in a similar manner to that in S11 of FIG. 7.

In S43, the controller 41 of the user terminal 40 starts the use of the vehicle by the user. Specifically, the user leases the vehicle 70 from the leasing operator.

As in operation example 1, the user may receive an advertising fee directly from the advertiser while paying a lease fee to the leasing operator. In this case, the contract information generated in S28 and S42 may include information that the advertiser pays the advertising fee to the user. The leasing operator may receive the advertising fee from the advertiser, and the user may pay the lease fee to the leasing operator after deducting an amount equivalent to the advertising fee. In this case, the contract information generated in S28 and S42 may include information that the lease fee for the vehicle is discounted by an amount equivalent to the advertising fee related to the advertisement placed on that vehicle.

Thus, in operation example 2, the information processing system 1 publishes vehicle information on a vehicle 70 to users and concludes a lease contract with a user, and then publishes the various conditions of the vehicle 70 to advertisers to determine an advertiser. Therefore, each advertiser can select a vehicle 70 that has the highest effect of the advertiser's advertisement placement, from among vehicles 70 combined with desired conditions for advertisement placement by users. Each user can select a desired vehicle from among vehicles 70 that include no advertisements, and apply for a lease contract.

The information processing system 1 determines an advertiser who places an advertisement on a vehicle using a bidding (auction) method, based on requests for advertisement placement received from one or more advertiser terminals 30. Therefore, the information processing system 1 can determine an optimal advertiser for the leasing operator and user by determining the advertiser from among multiple advertisers through a bidding method.

The information processing system 1 may accept an examination, by the leasing operator, of advertisement placement conditions included in each of requests for advertisement placement received from one or more advertiser terminals 30. The information processing system 1 may subject a request for advertisement placement related to advertisement placement conditions that have passed the examination to bidding. Therefore, the information processing system 1 can prevent advertisements that violate public order by accepting examinations for advertisement placement.

### Operation Example 3

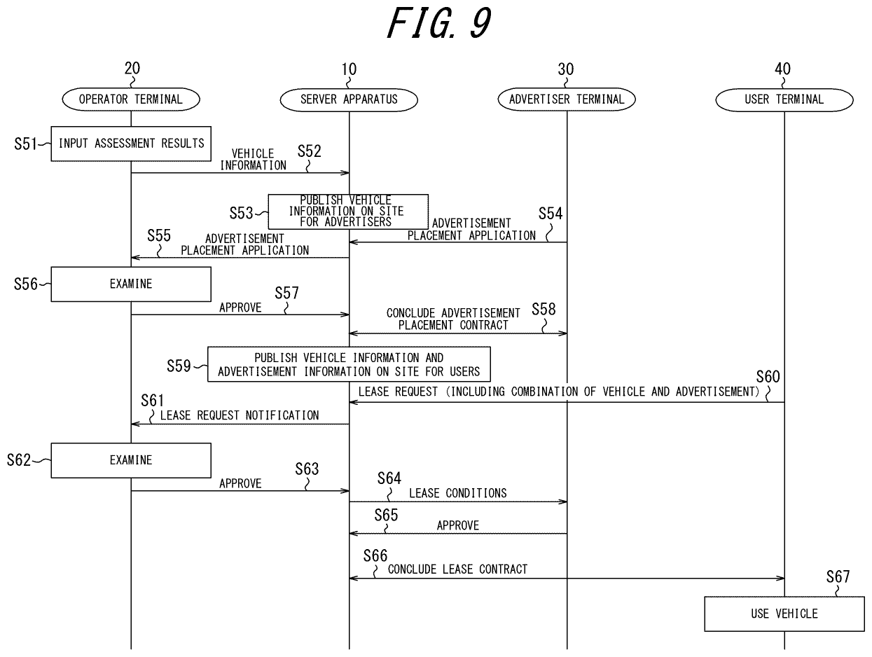

FIG. 9 is a sequence chart illustrating operation example 3 of the information processing system 1. In operation example 3, the information processing system 1 publishes vehicle information on vehicles 70 and advertisers' desired conditions to users, and accepts from a user a selection of a combination of a vehicle 70 and an advertisement to conclude a lease contract. The operations of the information processing system 1 described with reference to FIG. 9 can correspond to one of information processing methods according to the present embodiment. The operation of each step in FIG. 9 may be executed based on control by the controller 11 of the server apparatus 10, the controller 21 of the operator terminal 20, the controller 31 of the advertiser terminal 30, and/or the controller 41 of the user terminal 40. The following processing is executed in a situation in which vehicles 70 including damage 71 have been returned to a leasing operator, and the leasing operator has conducted an assessment of each vehicle 70.

In S51, the controller 21 of the operator terminal 20 accepts input of the assessment results from the leasing operator. The processing in S51 may be performed in a similar manner to that in S1 of FIG. 7.

In S52, the controller 21 of the operator terminal 20 transmits vehicle information acquired in S51 to the server apparatus 10 via the communication interface 23. Upon receiving the vehicle information from the operator terminal 20, the controller 11 of the server apparatus 10 registers the vehicle information in a database of the memory 12.

In S53, the controller 11 of the server apparatus 10 publishes the vehicle information on a website for advertisers. The processing in S53 may be performed in a similar manner to that in S3 of FIG. 7.

In S54, the controller 31 of each advertiser terminal 30 transmits an advertisement placement request to the server apparatus 10 via the communication interface 33. Here, in contrast to S4 of FIG. 7 and S35 of FIG. 8, the advertisement placement request does not include information identifying a vehicle 70 on which advertisement placement is desired. The advertisement placement request may include information such as the image and size of an advertisement sticker desired to be placed, conditions for a desired advertising fee, and a placement duration. The advertisement placement request may include conditions for vehicles 70 on which the advertiser desires advertisement placement. For example, the advertisement placement request may include information such as the colors, types, and manufacturers of the vehicles 70.

In S55, the controller 11 of the server apparatus 10 notifies the operator terminal 20 that there has been an advertisement placement request from the advertiser terminal 30.

In S56, the controller 21 of the operator terminal 20 examines whether to approve the advertisement placement by the advertiser to whom an advertising placement right has been granted, based on the determination of the leasing operator. The processing in S40 may be performed in a similar manner to that in S9 of FIG. 7.

In S57, when approving the advertisement placement based on the results of the examination in S56, the controller 21 of the operator terminal 20 notifies the server apparatus 10 of the approval.

In S58, the controller 11 of the server apparatus 10 generates contract information for the leasing operator and the advertiser to conclude an advertisement placement contract. For example, the controller 11 may generate information on a contract document that specifies contract conditions, and accept the advertiser's approval via the advertiser terminal 30. In contrast to S11 of FIG. 7, the contract conditions do not include information identifying a vehicle 70 on which the advertisement is placed.

In S59, the controller 11 of the server apparatus 10 publishes the vehicle information and advertisement information on a website for users. Specifically, the website for users may include a search screen for the vehicle information, and have the function of searching numerous pieces of vehicle information for those that meet search conditions input to the search screen and providing the search results. The website for users may provide detailed vehicle information on a vehicle 70 selected on the user terminal 40, from among the multiple vehicles 70 listed as the search results. The provided vehicle information may include information such as a lease fee and a duration. The website for users may include a search screen for the advertisement information, and have the function of searching numerous pieces of advertisement information for those that meet search conditions input to the search screen and providing the search results. The website for users may provide the details of a piece of advertisement information selected on the user terminal 40, from among the multiple pieces of advertisement information listed as the search results. The provided advertisement information may include information on the image and size of a sticker 80, an advertiser, and the like. The controller 11 publishes such vehicle information and advertisement information, and accepts, from each user terminal 40, a selection of a combination of a vehicle 70 and an advertisement. Each user accesses such a website using the user terminal 40, searches for a desired vehicle 70 and a desired advertisement, and selects a combination of the vehicle 70 and the advertisement.

In S60, the controller 41 of the user terminal 40 transmits a lease request for the combination of the vehicle 70 and the advertisement selected by the user to the server apparatus 10 via the communication interface 43. The user may select multiple combinations each consisting of a vehicle 70 and an advertisement, and apply for a lease with preference order.

In S61, the controller 11 of the server apparatus 10 notifies the operator terminal 20 that there has been a lease request from the user terminal 40 for the combination of the vehicle 70 and the advertisement.

In S62, the controller 21 of the operator terminal 20 examines whether to approve the lease to the user, based on the determination of the leasing operator. The processing in S62 may be performed in a similar manner to that in S16 of FIG. 7.

In S63, when approving the lease based on the results of the examination in S62, the controller 21 of the operator terminal 20 notifies the server apparatus 10 of the approval.

In S64, the controller 11 of the server apparatus 10 transmits lease conditions approved by the leasing operator to the advertiser terminal 30 of an advertiser who provides the advertisement to be affixed to the vehicle 70 for lease.

In S65, the controller 31 of the advertiser terminal 30 accepts the approval of the lease conditions according to an operation of the advertiser. When the lease conditions are approved, the controller 31 transmits the approval to the server apparatus 10. When it is stipulated in the contract information on the advertisement placement contract generated in S58 that the advertiser conclude the advertisement placement contract regardless of any vehicle 70 and any usage of the vehicle 70, the processing in S64 and S65 may be omitted.

In S66, the controller 11 of the server apparatus 10 generates contract information for the leasing operator and the user to conclude a lease contract. The processing in S28 may be performed in a similar manner to that in S18 of FIG. 7.

In S67, the controller 41 of the user terminal 40 starts the use of the vehicle by the user. Specifically, the user leases the vehicle 70 from the leasing operator.

As in operation examples 1 and 2, the user may receive an advertising fee directly from the advertiser while paying a lease fee to the leasing operator. In this case, the contract information generated in S58 and S66 may include information that the advertiser pays the advertising fee to the user. The leasing operator may receive the advertising fee from the advertiser, and the user may pay the lease fee to the leasing operator after deducting an amount equivalent to the advertising fee. In this case, the contract information generated in S58 and S66 may include information that the lease fee for the vehicle is discounted by an amount equivalent to the advertising fee related to the advertisement placed on that vehicle.

As described above, in operation example 3, the information processing system 1 publishes vehicle information on vehicles 70 and advertisers' desired conditions to users, and accepts from a user a selection of a combination of a vehicle 70 and an advertisement to conclude a lease contract. Therefore, each user can customize a combination of a vehicle 70 and an advertisement.

The information processing system 1 may also accept the registration of benefit contents associated with advertisement placement from the advertiser terminal 30, in addition to the advertisement placement request. The information processing system 1 may publish the vehicle information, the advertisement placement requests, and the benefit contents corresponding to the advertisement placement on the network N, and receive, from the user terminal 40, an application for a lease contract for a vehicle 70 including a combination of the vehicle 70 and an advertisement related to an advertisement placement request. By accepting the registration of the benefit contents associated with the advertisement placement, as described above, the information processing system 1 can allow the advertisers to differentiate themselves from other advertisers by bundling various benefit contents (for example, the provision of novelties).

The information processing system 1 may accept an examination, by the leasing operator, of advertisement placement conditions included in each of advertisement placement requests whose registrations are accepted from multiple advertiser terminals 30. The information processing system 1 may publish advertisement placement requests related to advertisement placement conditions of advertisements that have passed the examinations on the website on the network N. Therefore, the information processing system 1 can prevent advertisements that violate public order by accepting examinations for advertisement placement.

As described above, when there is damage on the exteriors of vehicles 70, the information processing system 1 according to the present disclosure achieves matching between a vehicle 70, an advertiser, and a user in a situation in which the vehicles 70 are assumed to be re-leased by covering the damage with advertisement stickers.

Specifically, the information processing system 1 includes the server apparatus 10, the one or more advertiser terminals 30 operated by advertisers, and the user terminal 40 operated by a user, which are communicable with each other via the network N. The information processing system 1 acquires vehicle information regarding a vehicle 70 for lease, which includes damage information indicating the state of a scratch on the exterior. The information processing system 1 publishes the vehicle information including the damage information on the network N, and receives, from the one or more advertiser terminals 30, requests for advertisement placement, including advertisement placement conditions, to affix advertising materials covering the scratch on the exterior of the vehicle 70. The information processing system 1 determines at least one advertiser who places an advertisement on the vehicle 70, based on the requests for advertisement placement received from the one or more advertiser terminals 30. The information processing system 1 publishes advertisement placement conditions of the determined at least one advertiser and the vehicle information on the network N, and receives, from the user terminal 40, an application for a lease contract for the vehicle 70 on which the advertisement by the determined at least one advertiser is placed. The information processing system 1 generates contract information to conclude the lease contract for the vehicle 70 on which the advertisement by the determined at least one advertiser is placed, with the user who operates the user terminal 40 from which the application has been received.

According to such a configuration, after determining the advertiser, the information processing system 1 publishes the various conditions of the vehicle 70 with the advertisement to the user, and concludes the lease contract in response to the lease application from the user. Therefore, the user can select the desired vehicle 70 from vehicles 70 combined with advertisements, and apply for the lease contract. The advertiser can place the advertisement on the vehicle 70 that meets the advertisement placement conditions.

The information processing system 1 includes the server apparatus 10, the one or more advertiser terminals 30 operated by advertisers, and the user terminal 40 operated by a user, which are communicable with each other via the network N. The information processing system 1 acquires vehicle information regarding a vehicle 70 for lease, which includes damage information indicating the state of a scratch on the exterior. The information processing system 1 publishes the vehicle information including the damage information on the network N, and receives an application for a lease contract for the vehicle 70 from the user terminal 40. The information processing system 1 generates contract information to conclude the lease contract for the vehicle 70, with the user who operates the user terminal 40 from which the application has been received. The information processing system 1 receives, from the user, desired conditions regarding advertisement placement that covers the scratch on the exterior of vehicle 70. The information processing system 1 publishes the vehicle information including the damage information and the desired conditions on the network N, and receives, from the one or more advertiser terminals 30, requests for advertisement placement, including advertisement placement conditions, for the vehicle 70. The information processing system 1 determines an advertiser who places an advertisement on the vehicle 70, based on the requests for advertisement placement received from the one or more advertiser terminals 30.

According to such a configuration, the information processing system 1 publishes the vehicle information on the vehicle 70 to the user and concludes the lease contract with the user, and then publishes the various conditions of the vehicle 70 to the advertisers to determine the advertiser. Therefore, the advertiser can select the vehicle 70 that has the highest effect of the advertiser's advertisement placement, from among vehicles 70 combined with desired conditions for advertisement placement by users. The user can select the desired vehicle 70 from among original vehicles 70 that include no advertisements, and apply for the lease contract.

The information processing system 1 includes the server apparatus 10, the one or more advertiser terminals 30 operated by advertisers, and the user terminal 40 operated by a user, which are communicable with each other via the network N. The information processing system 1 acquires multiple pieces of vehicle information regarding multiple vehicles 70 for lease, which includes damage information indicating the states of scratches on the exteriors. The information processing system 1 accepts, from the one or more advertiser terminals 30, registrations of advertisement placement requests, including advertisement placement conditions, to affix advertising materials covering the scratches on the exteriors of the vehicles 70. The information processing system 1 publishes the multiple pieces of vehicle information and the advertisement placement requests on the network N, and receives, from the user terminal 40, an application for a lease contract for a vehicle 70 including a combination of any vehicle 70 of the multiple vehicles 70 and at least one advertisement related to an advertisement placement request. The information processing system 1 generates contract information to conclude the lease contract for the vehicle 70, with the user who operates the user terminal 40 from which the application has been received.

According to such a configuration, the information processing system 1 publishes the vehicle information on the vehicles 70 and the advertisers' desired conditions to the user, and accepts from the user the selection of the combination of the vehicle 70 and the advertisement to conclude the lease contract. Therefore, each user can customize a combination of a vehicle 70 and an advertisement.

Search screens may be displayed on the advertiser terminals 30 and the user terminal 40, to search numerous pieces of vehicle information for those that meet search conditions input to the search screen, and display the search results on the advertiser terminals 30 and the user terminal 40. For example, the information processing system 1 may display, on each of the one or more advertiser terminals 30, a first search screen that allows input of search conditions regarding advertisement placement conditions, search multiple pieces of vehicle information for those that meet the search conditions input to the first search screen, and display the search results on each of the one or more advertiser terminals 30. The information processing system 1 may display, on the user terminal 40, a second search screen that allows input of search conditions regarding the advertisers' advertisement placement conditions and/or vehicle information, search multiple pieces of vehicle information for those that meet the search conditions input to the second search screen, and display the search results on the user terminal 40. According to such a configuration, the advertisers and the user can easily identify vehicle information that satisfies desired conditions.

The information processing system 1 may display, on the user terminal 40, a third search screen that allows input of search conditions regarding vehicle information, search multiple pieces of vehicle information for those that meet the search conditions input to the third search screen, and display the search results on the user terminal 40. The information processing system 1 may display, on the user terminal 40, a fourth search screen that allows input of search conditions regarding advertisement, search multiple advertisement placement requests for those that meet the search conditions input to the fourth search screen, and display the search results on the user terminal 40. According to such a configuration, the user can easily identify vehicle information and advertisements that satisfy desired conditions.

The information processing system 1 may generate images of vehicles 70 with advertisements affixed to damaged parts of the exteriors of the vehicles 70, and display the images on the user terminal 40. According to such a configuration, the user can easily recognize the states of the vehicles 70 with advertising materials affixed, and select a vehicle 70, an advertisement, and the like.

The present disclosure is not limited to the embodiment described above. For example, a plurality of blocks described in the block diagram may be integrated, or a single block may be divided. Instead of executing a plurality of steps described in the flowchart in chronological order in accordance with the description, the steps may be executed in parallel or in a different order according to the processing capability of the apparatus that executes each step, or as required. Other modifications can be made without departing from the spirit of the present disclosure.

Examples of some embodiments of the present disclosure are described below. However, it should be noted that the embodiments of the present disclosure are not limited to these.
[Appendix 1] An information processing method performed by an information processing system comprising a server apparatus, one or more advertiser terminals operated by advertisers, and a user terminal operated by a user, the server apparatus, the one or more advertiser terminals, and the user terminal being configured to be communicable with each other via a network, the information processing method comprising:
acquiring multiple pieces of vehicle information regarding vehicles for lease, the multiple pieces of vehicle information including damage information indicating states of scratches on exteriors;
displaying, on each of the one or more advertiser terminals, a first search screen that allows input of a search condition regarding an advertisement placement condition, searching the multiple pieces of vehicle information for a piece of vehicle information that meets the search condition input to the first search screen, and displaying a search result on each of the one or more advertiser terminals;
receiving, from the one or more advertiser terminals, requests for advertisement placement, including advertisement placement conditions, to affix advertising materials covering the scratches on the exteriors of the vehicles;
determining one or more advertisers who place advertisements on the vehicles, based on the requests for advertisement placement received from the one or more advertiser terminals;
displaying, on the user terminal, a second search screen that allows input of a search condition regarding the advertisers' advertisement placement conditions and/or vehicle information, searching the multiple pieces of vehicle information for a piece of vehicle information that meets the search condition input to the second search screen, and displaying a search result on the user terminal;
receiving, from the user terminal, an application for a lease contract for a vehicle on which an advertisement by an advertiser of the determined one or more advertisers is placed; and
generating contract information to conclude the lease contract for the vehicle on which the advertisement by the advertiser of the determined one or more advertisers is placed, with the user who operates the user terminal from which the application has been received.
[Appendix 2] An information processing method performed by an information processing system comprising a server apparatus, one or more advertiser terminals operated by advertisers, and a user terminal operated by a user, the server apparatus, the one or more advertiser terminals, and the user terminal being configured to be communicable with each other via a network, the information processing method comprising:
acquiring multiple pieces of vehicle information regarding multiple vehicles for lease, the multiple pieces of vehicle information including damage information indicating states of scratches on exteriors;
accepting, from the one or more advertiser terminals, registrations of multiple advertisement placement requests, including advertisement placement conditions, to affix advertising materials covering the scratches on the exteriors of the vehicles;
displaying, on the user terminal, a third search screen that allows input of a search condition related to vehicle information, searching the multiple pieces of vehicle information for a piece of vehicle information that meets the search condition input to the third search screen, and displaying a search result on the user terminal;
displaying, on the user terminal, a fourth search screen that allows input of a search condition related to advertisement, searching the multiple advertisement placement requests for an advertisement placement request that meets the search condition input to the fourth search screen, and displaying a search result on the user terminal;
receiving, from the user terminal, an application for a lease contract for a vehicle, the application including a combination of any vehicle of the multiple vehicles and at least one advertisement related to the advertisement placement request; and
generating contract information to conclude the lease contract for the vehicle with the user who operates the user terminal from which the application has been received.
[Appendix 3] An information processing method performed by an information processing system comprising a server apparatus, one or more advertiser terminals operated by advertisers, and a user terminal operated by a user, the server apparatus, the one or more advertiser terminals, and the user terminal being configured to be communicable with each other via a network, the information processing method comprising:
acquiring vehicle information regarding a vehicle for lease, the vehicle information including damage information indicating a state of a scratch on an exterior;
publishing the vehicle information including the damage information on the network, and receiving, from the one or more advertiser terminals, requests for advertisement placement, including advertisement placement conditions, to affix advertising materials covering the scratch on the exterior of the vehicle;
determining at least one advertiser who places an advertisement on the vehicle, based on the requests for advertisement placement received from the one or more advertiser terminals;
publishing an advertisement placement condition of the determined at least one advertiser and the vehicle information on the network, and receiving, from the user terminal, an application for a lease contract for the vehicle on which the advertisement by the determined at least one advertiser is placed; and
generating contract information to conclude the lease contract for the vehicle on which the advertisement by the determined at least one advertiser is placed, with the user who operates the user terminal from which the application has been received.
[Appendix 4] An information processing method performed by an information processing system comprising a server apparatus, one or more advertiser terminals operated by advertisers, and a user terminal operated by a user, the server apparatus, the one or more advertiser terminals, and the user terminal being configured to be communicable with each other via a network, the information processing method comprising:
acquiring vehicle information regarding a vehicle for lease, the vehicle information including damage information indicating a state of a scratch on an exterior;
publishing the vehicle information including the damage information on the network, and receiving, from the user terminal, an application for a lease contract for the vehicle;
generating contract information to conclude the lease contract for the vehicle with the user who operates the user terminal from which the application has been received;
receiving, from the user, a desired condition related to advertisement placement to affix an advertising material covering the scratch on the exterior of the vehicle;
publishing the vehicle information including the damage information and the desired condition on the network, and receiving, from the one or more advertiser terminals, requests for advertisement placement, including advertisement placement conditions, for the vehicle; and
determining an advertiser who places an advertisement on the vehicle, based on the requests for advertisement placement received from the one or more advertiser terminals.
[Appendix 5] An information processing method performed by an information processing system comprising a server apparatus, one or more advertiser terminals operated by advertisers, and a user terminal operated by a user, the server apparatus, the one or more advertiser terminals, and the user terminal being configured to be communicable with each other via a network, the information processing method comprising:
acquiring multiple pieces of vehicle information regarding multiple vehicles for lease, the multiple pieces of vehicle information including damage information indicating states of scratches on exteriors;
accepting, from the one or more advertiser terminals, registrations of advertisement placement requests, including advertisement placement conditions, to affix advertising materials covering the scratches on the exteriors of the vehicles;
publishing the multiple pieces of vehicle information and the advertisement placement requests on the network, and receiving, from the user terminal, an application for a lease contract for a vehicle, the application including a combination of any vehicle of the multiple vehicles and at least one advertisement related to an advertisement placement request; and
generating contract information to conclude the lease contract for the vehicle with the user who operates the user terminal from which the application has been received.
[Appendix 6] The information processing method according to appendix 5, comprising:
accepting, in addition to the advertisement placement requests, registrations of benefit contents associated with advertisement placement from the one or more advertiser terminals; and
publishing the multiple pieces of vehicle information, the advertisement placement requests, and the benefit contents corresponding to the advertisement placement on the network, and receiving, from the user terminal, an application for a lease contract for a vehicle, the application including a combination of any vehicle of the multiple vehicles and an advertisement related to an advertisement placement request.
[Appendix 7] The information processing method according to any one of appendices 3 to 6, wherein the contract information includes information that the advertiser pays the user an advertising fee.
[Appendix 8] The information processing method according to any one of appendices 3 to 6, wherein the contract information includes information that a lease fee for the vehicle is discounted by an amount equivalent to an advertising fee related to the advertisement placed on that vehicle.
[Appendix 9] The information processing method according to appendix 3 or 4, comprising determining the advertiser who places the advertisement on the vehicle by a bidding method, based on the requests for advertisement placement received from the one or more advertiser terminals.
[Appendix 10] The information processing method according to appendix 9, comprising:
accepting an examination, by a leasing operator, of an advertisement placement condition included in each of the requests for advertisement placement received from the one or more advertiser terminals; and
subjecting a request for advertisement placement related to an advertisement placement condition that has passed the examination to bidding.
[Appendix 11] The information processing method according to appendix 6, comprising:
accepting an examination, by a leasing operator, of an advertisement placement condition included in each of the advertisement placement requests whose registrations have been accepted from the one or more advertiser terminals; and
publishing an advertisement placement request related to an advertisement placement condition that has passed the examination on the network.
[Appendix 12] A program configured to control a computer configured to be communicable with one or more advertiser terminals operated by advertisers and a user terminal operated by a user via a network, the program configured to cause a processor to execute operations, the operations comprising:
acquiring vehicle information regarding a vehicle for lease, the vehicle information including damage information indicating a state of a scratch on an exterior;
publishing the vehicle information including the damage information on the network, and receiving, from the one or more advertiser terminals, requests for advertisement placement, including advertisement placement conditions, to affix advertising materials covering the scratch on the exterior of the vehicle;
determining at least one advertiser who places an advertisement on the vehicle, based on the requests for advertisement placement received from the one or more advertiser terminals;
publishing an advertisement placement condition of the determined at least one advertiser and the vehicle information on the network, and receiving, from the user terminal, an application for a lease contract for the vehicle on which the advertisement by the determined at least one advertiser is placed; and
generating contract information to conclude the lease contract for the vehicle on which the advertisement by the determined at least one advertiser is placed, with the user who operates the user terminal from which the application has been received.
[Appendix 13] A program configured to control a computer configured to be communicable with one or more advertiser terminals operated by advertisers and a user terminal operated by a user via a network, the program configured to cause a processor to execute operations, the operations comprising:
acquiring vehicle information regarding a vehicle for lease, the vehicle information including damage information indicating a state of a scratch on an exterior;
publishing the vehicle information including the damage information on the network, and receiving, from the user terminal, an application for a lease contract for the vehicle;
generating contract information to conclude the lease contract for the vehicle with the user who operates the user terminal from which the application has been received;
receiving, from the user, a desired condition related to advertisement placement to affix an advertising material covering the scratch on the exterior of the vehicle;
publishing the vehicle information including the damage information and the desired condition on the network, and receiving, from the one or more advertiser terminals, requests for advertisement placement, including advertisement placement conditions, for the vehicle; and
determining an advertiser who places an advertisement on the vehicle, based on the requests for advertisement placement received from the one or more advertiser terminals.
[Appendix 14] A program configured to control a computer configured to be communicable with one or more advertiser terminals operated by advertisers and a user terminal operated by a user via a network, the program configured to cause a processor to execute operations, the operations comprising:
acquiring multiple pieces of vehicle information regarding multiple vehicles for lease, the multiple pieces of vehicle information including damage information indicating states of scratches on exteriors;
accepting, from the one or more advertiser terminals, registrations of advertisement placement requests, including advertisement placement conditions, to affix advertising materials covering the scratches on the exteriors of the vehicles;
publishing the multiple pieces of vehicle information and the advertisement placement requests on the network, and receiving, from the user terminal, an application for a lease contract for a vehicle, the application including a combination of any vehicle of the multiple vehicles and at least one advertisement related to an advertisement placement request; and
generating contract information to conclude the lease contract for the vehicle with the user who operates the user terminal from which the application has been received.
[Appendix 15] The program according to appendix 14, wherein the operations comprise:
accepting, in addition to the advertisement placement requests, registrations of benefit contents associated with advertisement placement from the one or more advertiser terminals; and
publishing the multiple pieces of vehicle information, the advertisement placement requests, and the benefit contents corresponding to the advertisement placement on the network, and receiving, from the user terminal, an application for a lease contract for a vehicle, the application including a combination of any vehicle of the multiple vehicles and an advertisement related to an advertisement placement request.
[Appendix 16] The program according to any one of appendices 12 to 15, wherein the contract information includes information that the advertiser pays the user an advertising fee.
[Appendix 17] The program according to any one of appendices 12 to 15, wherein the contract information includes information that a lease fee for the vehicle is discounted by an amount equivalent to an advertising fee related to the advertisement placed on that vehicle.
[Appendix 18] The program according to appendix 12 or 13, wherein the operations comprise determining the advertiser who places the advertisement on the vehicle by a bidding method, based on the requests for advertisement placement received from the one or more advertiser terminals.
[Appendix 19] The program according to appendix 18, wherein the operations comprise:
accepting an examination, by a leasing operator, of an advertisement placement condition included in each of the requests for advertisement placement received from the one or more advertiser terminals; and
subjecting a request for advertisement placement related to an advertisement placement condition that has passed the examination to bidding.
[Appendix 20] The program according to appendix 15, wherein the operations comprise:
accepting an examination, by a leasing operator, of an advertisement placement condition included in each of the advertisement placement requests whose registrations have been accepted from the one or more advertiser terminals; and
publishing an advertisement placement request related to an advertisement placement condition that has passed the examination on the network.

1-20. (canceled)

21. An information processing method performed by an information processing system comprising a server apparatus, one or more advertiser terminals operated by advertisers, and a user terminal operated by a user, the server apparatus, the one or more advertiser terminals, and the user terminal being configured to be communicable with each other via a network, the information processing method comprising:
acquiring vehicle information regarding a vehicle for lease, the vehicle information including damage information indicating a state of a scratch on an exterior;
publishing the vehicle information including the damage information on the network, and receiving, from the one or more advertiser terminals, requests for advertisement placement, including advertisement placement conditions, to affix advertising materials covering the scratch on the exterior of the vehicle;
determining at least one advertiser who places an advertisement on the vehicle, based on the requests for advertisement placement received from the one or more advertiser terminals;
publishing an advertisement placement condition of the determined at least one advertiser and the vehicle information on the network, and receiving, from the user terminal, an application for a lease contract for the vehicle on which the advertisement by the determined at least one advertiser is placed; and
generating contract information to conclude the lease contract for the vehicle on which the advertisement by the determined at least one advertiser is placed, with the user who operates the user terminal from which the application has been received.

22. An information processing method performed by an information processing system comprising a server apparatus, one or more advertiser terminals operated by advertisers, and a user terminal operated by a user, the server apparatus, the one or more advertiser terminals, and the user terminal being configured to be communicable with each other via a network, the information processing method comprising:
acquiring vehicle information regarding a vehicle for lease, the vehicle information including damage information indicating a state of a scratch on an exterior;
publishing the vehicle information including the damage information on the network, and receiving, from the user terminal, an application for a lease contract for the vehicle;
generating contract information to conclude the lease contract for the vehicle with the user who operates the user terminal from which the application has been received;
receiving, from the user, a desired condition related to advertisement placement to affix an advertising material covering the scratch on the exterior of the vehicle;
publishing the vehicle information including the damage information and the desired condition on the network, and receiving, from the one or more advertiser terminals, requests for advertisement placement, including advertisement placement conditions, for the vehicle; and
determining an advertiser who places an advertisement on the vehicle, based on the requests for advertisement placement received from the one or more advertiser terminals.

23. An information processing method performed by an information processing system comprising a server apparatus, one or more advertiser terminals operated by advertisers, and a user terminal operated by a user, the server apparatus, the one or more advertiser terminals, and the user terminal being configured to be communicable with each other via a network, the information processing method comprising:
acquiring multiple pieces of vehicle information regarding multiple vehicles for lease, the multiple pieces of vehicle information including damage information indicating states of scratches on exteriors;
accepting, from the one or more advertiser terminals, registrations of advertisement placement requests, including advertisement placement conditions, to affix advertising materials covering the scratches on the exteriors of the vehicles;
publishing the multiple pieces of vehicle information and the advertisement placement requests on the network, and receiving, from the user terminal, an application for a lease contract for a vehicle, the application including a combination of any vehicle of the multiple vehicles and at least one advertisement related to an advertisement placement request; and
generating contract information to conclude the lease contract for the vehicle with the user who operates the user terminal from which the application has been received.

24. The information processing method according to claim 23, comprising:
accepting, in addition to the advertisement placement requests, registrations of benefit contents associated with advertisement placement from the one or more advertiser terminals; and
publishing the multiple pieces of vehicle information, the advertisement placement requests, and the benefit contents corresponding to the advertisement placement on the network, and receiving, from the user terminal, an application for a lease contract for a vehicle, the application including a combination of any vehicle of the multiple vehicles and an advertisement related to an advertisement placement request.

25. The information processing method according to claim 21, wherein the contract information includes information that the advertiser pays the user an advertising fee.

26. The information processing method according to claim 21, wherein the contract information includes information that a lease fee for the vehicle is discounted by an amount equivalent to an advertising fee related to the advertisement placed on that vehicle.

27. The information processing method according to claim 21, comprising determining the advertiser who places the advertisement on the vehicle by a bidding method, based on the requests for advertisement placement received from the one or more advertiser terminals.

28. The information processing method according to claim 27, comprising:
accepting an examination, by a leasing operator, of an advertisement placement condition included in each of the requests for advertisement placement received from the one or more advertiser terminals; and
subjecting a request for advertisement placement related to an advertisement placement condition that has passed the examination to bidding.

29. The information processing method according to claim 24, comprising:
accepting an examination, by a leasing operator, of an advertisement placement condition included in each of the advertisement placement requests whose registrations have been accepted from the one or more advertiser terminals; and
publishing an advertisement placement request related to an advertisement placement condition that has passed the examination on the network.
